(19) United States
(12) Patent Application Publication
(10) Pub. No.: US 2022/0136836 A1
(43) Pub. Date: May 5, 2022

(54) SYSTEM AND METHOD FOR INDOOR NAVIGATION

(71) Applicant: Xerox Corporation, Norwalk, CT (US)

(72) Inventors: Fritz Francis Ebner, Pittsford, NY (US); Matthew David Levesque, Henrietta, NY (US); Aaron Zachary Borden, Pittsford, NY (US); Matthew Dylan Coene, Ontario, NY (US)

(21) Appl. No.: 17/088,786

(22) Filed: Nov. 4, 2020

(51) Int. Cl. G01C 21/20; G01C 21/34; G05D 1/00; G05D 1/02

(52) U.S. Cl. CPC G01C 21/206; G01C 21/3446; G05D 2201/0207; G05D 1/0217; G05D 1/0044

(57) ABSTRACT

This document discloses methods by which an electronic device may determine a navigable path to a destination in an indoor environment without requiring data from any location-based tracking system that is external to the electronic device. The device will receive a graph representation of a map of the indoor environment, with instances of objects represented as nodes of the graph, and with open area paths represented as edges of the graph. The device will determine multiple candidate paths from a starting location to the destination location. Each of the candidate paths will include a set of node-edge combinations that extend from the starting location to the destination location. The processor will identify which of the candidate paths is a shortest path, and it will use that path to identify a navigable path to the destination.

### BACKGROUND

Global positioning system (GPS) based navigation systems have become essential to help humans and robotic devices navigate from place to place. Such navigation systems rely on the ability of an electronic device's GPS receiver to receive signals from a network of GPS satellites. The GPS receiver will receive signals from multiple satellites, use the received signals to determine the location of each satellite and the receiver's distance from each signal's satellite, and use the determined locations and distances to calculate the receiver's coordinates.

Because GPS receivers must be able to receive signals from GPS satellites, GPS-based tracking is often of limited utility in indoor locations where the signals may be blocked by the building's structural elements. However, locations such as large office buildings, shopping centers, airports and the like may have any number of corridors, rooms, cubicles and other structures that can make finding an appropriate path to a destination difficult. Within such structures, people and robotic devices often need assistance navigating from place to place and finding specific items. GPS systems fail to adequately satisfy this need.

Other methods of indoor location tracking are known. Common methods include determining the location between the device and multiple beacons that are positioned throughout the building. However, these methods are prone to error, they require specialized equipment throughout the building, and often they cannot determine generate a path to a destination that avoids barriers and other objects placed within the building.

This document describes methods and systems that are directed to solving at least some of the issues described above.

### SUMMARY

A processor of an electronic device implements a method of determining a navigable path from a starting location to a destination location by determining a starting location in an indoor environment and determining a destination location in the indoor environment. The processor will receive a graph representation of a map of the indoor environment. The graph representation of the map will include instances of objects (represented as nodes of the graph), and open area paths between objects (represented as edges of the graph). The processor will determine multiple candidate paths from the starting location to the destination location. Each of the candidate paths will include a set of node-edge combinations that extend from the starting location to the destination location. The processor will identify which of the candidate paths is a shortest path from the starting point location to the destination object location, and it will select a path to navigate from the starting point location to the destination location. The selected path will be considered to be the shortest path. When the processor determines the candidate paths and identifies the shortest path, it will do so without requiring data from any location-based tracking system that is external to the electronic device.

Optionally, a server may receive a digital image of a floor plan of the indoor environment, extract text from the digital image, and associate an object with each extracted text and graphic identifier. The server also may use the extracted text to assign classes and identifiers to at least some of the associated objects. The server also may determine a location in the image of at least some of the associated objects. The server also may save the assigned identifiers and locations in the image of the associated objects to a data set. The server also may generate the representation of the map in which: (a) instances of objects comprise the associated objects for which the server determined classes and relative locations appear as instances of objects, and (b) locations in which no objects were detected appear as open areas.

Optionally, a server may receive a digital image file of a floor plan of the indoor location, parse the digital image file to identify objects within the floor plan and locations of the identified objects within the floor plan, and assign classes and identifiers to at least some of the identified objects. The server may then determining a location in the image of at least some of the identified objects, saving the assigned identifiers and locations of the identified objects to a data set. The server also may be used to generate the representation of the map in which: (a) identified objects for which the server determined classes and relative locations appear as instances of objects, and (b) locations in which no objects were detected appear as open areas.

In some embodiments, the processor may cause a display of the electronic device to output the shortest path so that the shortest path appears on the map of the indoor environment.

Optionally, when the processor determines which the candidate paths is the shortest path, the processor may use Dykstra's algorithm or the Astar algorithm to do so.

Optionally, determining the destination location may include receiving, from a user of the electronic device, a selection of the destination location via a user interface by one or more of the following: (i) receiving an identifier of the destination location or of a destination object via an input field; (ii) receiving a selection of the destination location or of the destination object on the map of the indoor environment as presented on the user interface; or (ii) outputting a list of candidate designation locations or destination objects and receiving a selection of the destination object or the destination object from the list.

In some embodiments, the electronic device may be an autonomous robotic device. If so, then a navigation system of the autonomous robotic device may cause the autonomous robotic device to move along the shortest path to the destination location.

In some embodiments, the processor of the electronic device may execute a document processing application and, in the operation, identify the destination location as a location of a print device to which a document is to be printed. If so, the processor also may cause a document to be printed to the print device.

The disclosure also relates to a system for determining a navigable path to a print device in an indoor environment. The system includes a processor and a memory device containing programming instructions that are configured to cause the processor to identify a destination location. Optionally, the memory device also many include instructions to execute a document processing application and, in the operation, cause a document to be printed to a print device, in which case the destination location may be the location of the print device. The system will receive a graph representation of a map of the indoor environment. The graph representation of the map will include instances of objects represented as nodes of the graph, and open area paths between objects represented as edges of the graph. In embodiments that include the document processing application, at least one of the instances of objects may correspond to the print device. Without requiring data from any location-based tracking system that is external to the system, the system will determine a plurality of candidate paths from a starting location to the destination location. Each of the candidate paths will comprise a set of node-edge combinations that extend from a starting location to the location of the print device (or other destination location). The system will identify which of the plurality of candidate paths is a shortest path from the starting location to the destination location, and it will select the shortest path as a path to navigate from the starting location to the destination location. Optionally, the system may include a display device, in which case the system may include programming instructions are further configured to cause the processor to output the shortest path on the display device so that the shortest path appears on the map of the indoor environment. Also optionally, the processor is a component of an autonomous robotic device that has a navigation system, in which case the programming instructions also may include instructions configured to instruct the processor to cause the navigation system to move the autonomous robotic device along the shortest path to the destination location.

### BRIEF DESCRIPTION OF THE DRAWINGS

FIG. 1 illustrates an example floor plan of a building, with locations of multiple items in the building.

FIG. 2 is a flowchart illustrating an example process of ingesting map data into an indoor navigation system.

FIG. 3 illustrates a beginning of a graph development process in which objects from the floor plan of FIG. 1 are shown as waypoints.

FIGS. 4A and 4B illustrate a next step in a graph development process in which polylines are added to the graph.

FIG. 5 illustrates an example process of using a graph representation of a building floor plan to navigate within the floor plan.

FIGS. 6A-6D illustrate user interfaces of a navigation application.

FIG. 7 illustrates components of an example electronic device.

### DETAILED DESCRIPTION

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.”

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

Additional terms that are relevant to this disclosure will be defined at the end of this Detailed Description section.

This document describes an improved method for locating items and destinations in an indoor environment, without the use of location-based tracking systems that require specialized hardware that are external to the device itself, such as GPS tracking receivers or beacon-based triangulation systems. The method can be used to pinpoint the location of a mobile electronic device that a user is carrying around the building or that is automatically moving around a building. The method can also be used to quickly determine the location of stationary objects, such as print devices or other equipment, in order to help devices, users and/or others (such as maintenance personnel) quickly locate a particular device within a building. In a building that contains one or more Wi-Fi networks and multiple network access points, the method can leverage existing equipment and does not require the installation of additional location devices such as beacons or cameras positioned within the building, or tags that are attached to the electronic device.

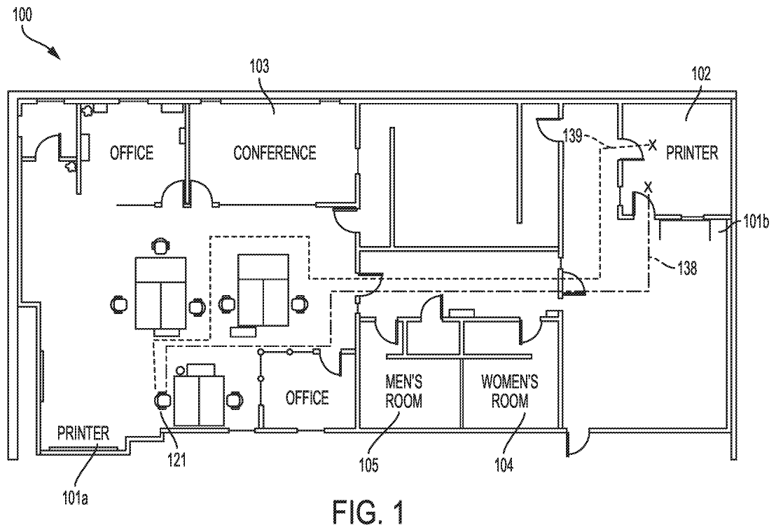

FIG. 1 depicts an example floor map 100 of a floor of an office building. The building includes various rooms (such as cafeteria 102, conference room 103, women's bathroom 104 and men's bathroom 105), corridors, doors, items such as print devices 101a, 101b and obstacles such as desks and chairs (including chair 121).

A system may store a digital representation of a floor map 100 such as that shown. The floor map 100 may include object labels in the form of text such as room name labels (such as cafeteria 102, conference room 103, women's bathroom 104 and men's bathroom 105). The floor map 100 also may object labels that represent certain classes of items located in the building, such as object labels representing print devices 101a, 101b and chair 121.

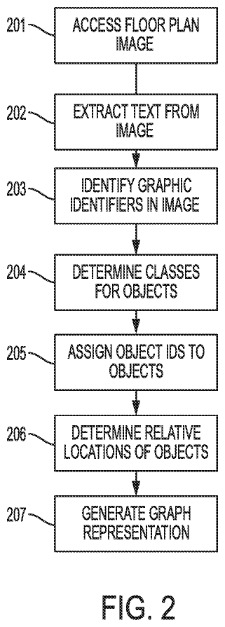

FIG. 2 illustrates a process by which a server may ingest a floor map such as floor map 100 of FIG. 1 to create a data set that the system may use to enable an indoor navigation process. The system may receive the digital floor map as an image file or map file at 201, and at 202 the system will analyze the floor map image or map file to extract text-based labels and relative locations of objects in the location that are associated with each label. For example, with reference to FIG. 1, the system may use any suitable text extraction process, such as optical character recognition, to process an image and extract text such as “café” 102, “conference” 103, “women's room” 104, “men's room” 105, “office” 107 and 108, “chair” 121 and “printer” 101a and 101b. Alternatively, if the file is a map file having a searchable structure the system may parse the file for object labels and extract the labels and object locations from the file, without the need for image analysis.

Returning to FIG. 2, at 204 the system may compare the extracted text with a data set of object classes to determine whether any label matches a known object class, either as an exact match or via a semantically similar match (example: the word “café” is considered semantically similar to “cafeteria”), and if so the system will assign the object to that class. At 205 the system will also assign an object identifier to each object. Each object identifier may be unique, objects of the same class may share common object identifiers, or the system may be a hybrid of the two in which some identifiers are unique and some are shared. At 206 the system will also determine a relative location of the object with respect to a reference point in the image (such as a number of pixels down and to the right of the top leftmost pixel in the image). At 207 the system may then translate the image map to a graph representation in which each identified object appears as an object instance, and the centerpoint (or another appropriate segment of) each object label is a waypoint (i.e., a node on the graph) and paths between waypoints are edges of the graph.

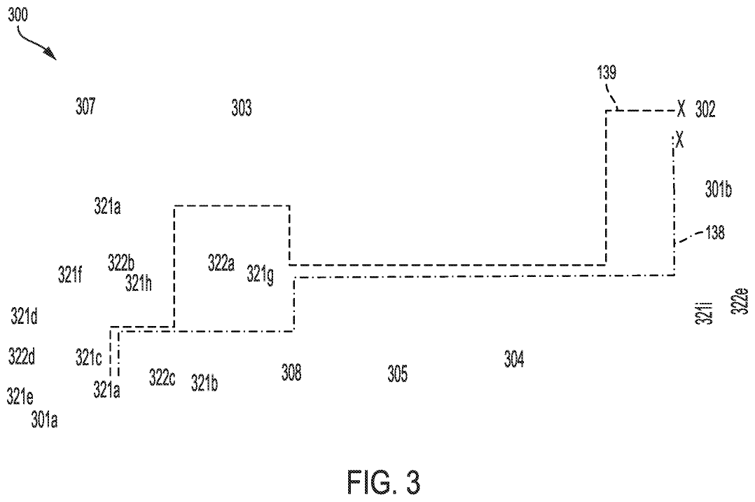

FIG. 3 illustrates an example portion of the graph representation 300 in which the labels represent instances of objects (example: printers 301a and 301b, cafeteria 302, conference room 303, women's room 304, men's room 305, offices 307 and 308, and chairs 321a), and at least the center point of each label is designated as the object location. (Optionally, one or more pixels adjacent to the centerpoint also may be considered to be part of the waypoint.) The system will then generate polylines between the waypoints using any suitable process, such as skeletonization, manual drawing, or another process.

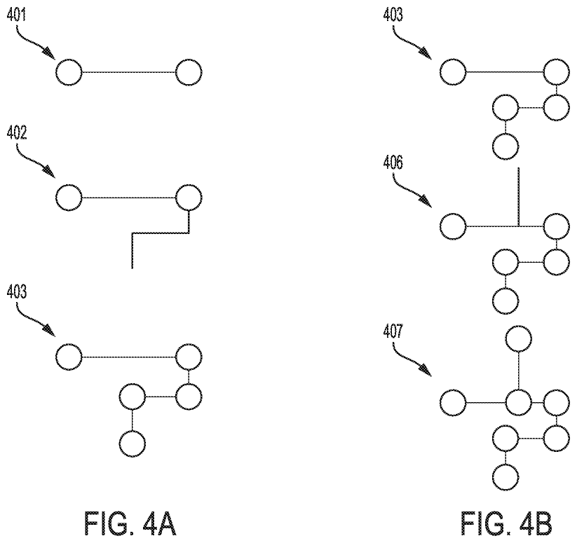

For example, in a skeletonization process the process will start a polyline will start at one node, analyze neighboring pixels of the node, and advance the polyline in a direction in which pixel is not blocked by waypoint or by a building structural element such as a wall. The system will then build the graph representation of paths that may be followed from a starting point to the destination along the polylines. For example, referring to FIGS. 4A and 4B, to build the graph the system may connect a polyline to the graph when the polyline's vertex matches a note position. This is shown in FIG. 4A, where at 401 the polyline begins with two nodes and extends beyond the second node at 402. At 403 each node on the polyline that is less than one pixel from the node is connected to the graph. In FIG. 4B, the system starts with the graph portion of 402 and also may identify nodes whose normal (see 405) is a designated number (e.g., two) or fewer pixels from any edge. At 407 the system will extend the graph to such nodes.

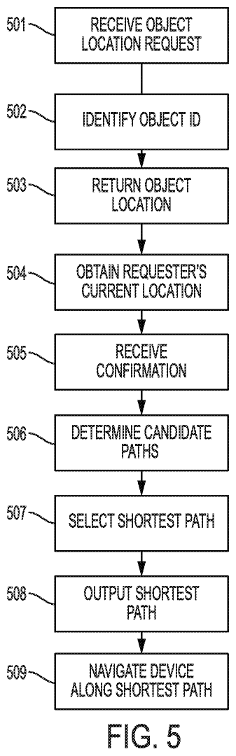

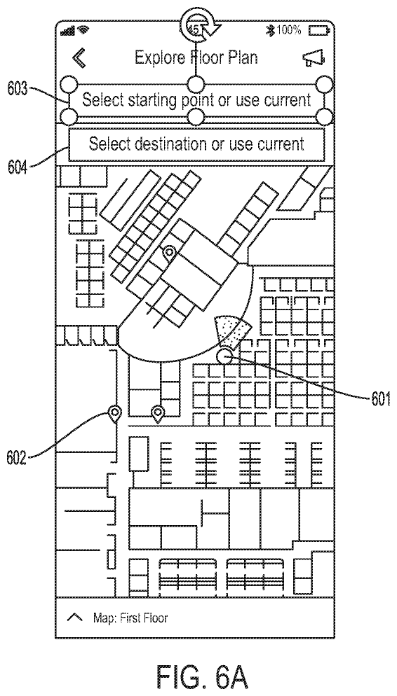

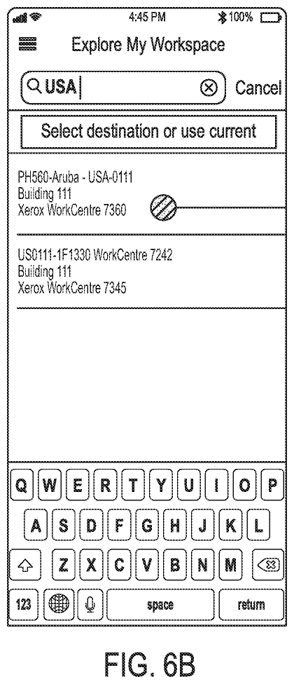

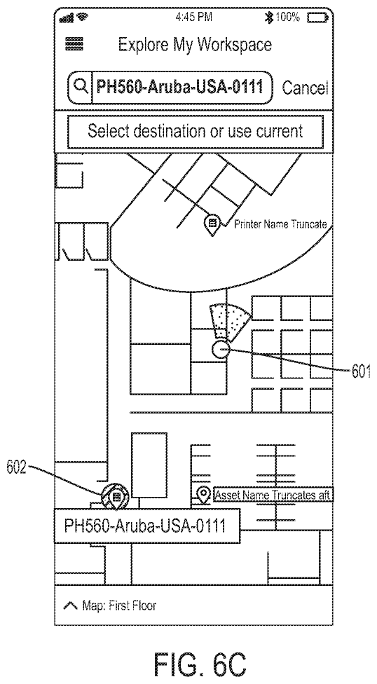

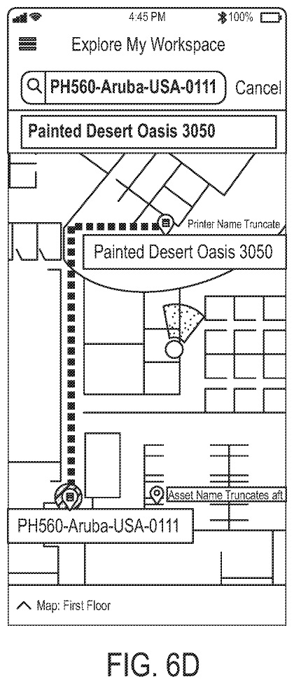

When the graph representation 300 is complete, then referring to FIGS. 5 and 6A at 501 the system may receive a request to locate and/or navigate to an object. For example, the system may include an application operable on a mobile electronic device that outputs a user interface for an indoor mapping application. The system may select a starting location 504 of the requester by receiving a location or object ID entered into an input field 603, by receiving a selection of the location 601 as output on a displayed map or by another process, such as by choosing from a list of possible starting points within the map. Some systems may include a speech to text converter in which a user may enter a destination via microphone. A starting point may be detected as a relative position on the map with respect to the reference point that was used to determine the locations of objects on the map. Alternatively, the starting point may be determined as the location of a closest known object. If the location is not already displayed on the displayed map, the location may be displayed after the user enters it.

At 501 the request to locate and/or navigate to an destination location also may include an identification or location of a destination object 602. As with the starting location, the destination location 602 may be received as an identifier of an object that is positioned at the designation location, or as the location itself, entered into an input field 604, by receiving a selection of the object or destination location 603 on a displayed map, by outputting a list of objects and/or locations and receiving a selection from the list, by speech-to-text input or by another process. The system may access its data set of object IDs and locations and return a name at 502 and location at 503 for the object ID.

Optionally, as shown in FIGS. 5 and 6B at 505 the system may output the starting location and the destination location (either as the location, as the object positioned at the location) for the user to confirm, and if multiple candidate destinations are possible the system may output each of them and require the user to select one of the candidate destinations as the confirmed destination. Upon receipt of confirmation the system may output a map rendering (FIG. 6C) that shows the starting point and destination location, optionally after zooming the map in or out as needed to show both locations on the map.

When the system determines the starting location and destination location, at 506 the system may then compute multiple candidate paths from the starting location to the destination location. The system may do this by any suitable method, for example by following the graph representation in which all the starting and destination locations are represented as nodes, and edges describe all paths between nodes on the graph, which are in open spaces of the building. Open spaces may include areas that do not include objects, or areas that include objects that may be passed through (such as doors). The system may then determine the candidate paths as node-edge combinations that extend from the starting node to the destination node, such as by finding the closest node on the graph to that location, and connecting to that item via the graph. Two candidate paths 138 and 139 are shown by way of example in the floor plan 100 of FIG. 1. At 507 the system may then determine a shortest path using a method such as Dykstra's algorithm or the Astar algorithm. Then, at 508 the system may output the shortest path on the displayed map to help the device user navigate to the destination, as shown in FIG. 6D.

In some embodiments, instead of a mobile device application, the steps of FIG. 5 may be performed by an autonomous robotic device. If so, the system may not need to output the user interfaces of FIGS. 6A-6D but instead may simply implement the process of FIG. 5 and then at step 509 use the determined path as a planned path to navigate the robotic device along the path using any now or hereafter known autonomous device operation process. Robotic navigation processes such as those well known in the art may be used to implement this step.

Also optionally, the process above may be integrated with other electronic device applications to guide a user of the device to a location at which the device causes an operation. For example, a document printing application of an electronic device may output a print job to a selected printer, and then present a user of the device with a path to reach the selected printer. (FIG. 6D illustrates an example of how this may appear to a user of the device.)

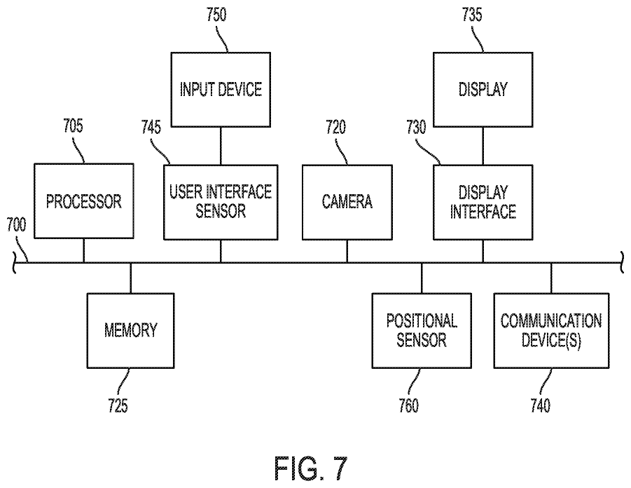

FIG. 7 depicts an example of internal hardware that may be included in any of the electronic components of the system, such as (a) the server that ingests a map and communicatively shares map data with other devices, (b) any of the electronic devices that are carried or within the building, or (c) a robotic device that moves throughout the building. An electrical bus 700 serves as an information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 725. A memory device may include a single device or a collection of devices across which data and/or instructions are stored. The memory device may store data, such as the data set of access point information described above.

An optional display interface 730 may permit information from the bus 700 to be displayed on a display device 735 in visual, graphic or alphanumeric format. An audio interface and audio output (such as a speaker) also may be provided. Communication with external devices may occur using various communication devices 740 such as a wireless antenna, an RFID tag and/or short-range or near-field communication transceiver, each of which may optionally communicatively connect with other components of the device via one or more communication system. The communication device 740 may be configured to be communicatively connected to a communications network, such as the Internet, a local area network or a cellular telephone data network.

The hardware may also include a user interface sensor 745 that allows for receipt of data from input devices 750 such as a keyboard, a mouse, a joystick, a touchscreen, a touch pad, a remote control, a pointing device and/or microphone. The system also may include positional sensors 780 such as a global positioning system (GPS) sensor device that receives positional data from an external GPS network.

Terminology that is relevant to this disclosure includes:

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, laptop computers, digital display devices, print devices, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 6.

The term “print device” refers to a machine having hardware capable of reading a digital document file and use the information from the file and associated print instructions to print of a physical document on a substrate. Components of a print device typically include a print engine, which includes print hardware such as a print head, which may include components such as a print cartridge containing ink, toner or another print material, as well as a document feeding system configured to pass a substrate through the print device so that the print head can print characters and/or images on the substrate. In some embodiments, a print device may have additional capabilities such as scanning or faxing and thus may be a multifunction device.

The term “print job” refers to a set of digital data that represents text, images and/or other content that a print device will print on a substrate

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of determining a navigable path in an indoor environment, the method comprising, by a processor of an electronic device:
determining a starting location and a destination location, wherein one or both of the locations is located in an indoor environment;
receiving a graph representation of a map of the indoor environment, wherein the graph representation of the map includes instances of objects represented as nodes of the graph, and open area paths between objects represented as edges of the graph;
determining a plurality of candidate paths from the starting location to the destination location, wherein each of the plurality of candidate paths comprises a set of node-edge combinations that extend from the starting location to the destination location;
identifying which of the plurality of candidate paths is a shortest path from the starting point location to the destination object location; and
selecting the shortest path as a path to navigate from the starting location to the destination location,
wherein the processor performs determining the plurality of candidate paths, identifying the shortest path, and selecting the shortest path without requiring data from any location-based tracking system that is external to the electronic device.

2. The method of claim 1 further comprising, by a server:
receiving a digital image of a floor plan of the indoor environment;
extracting text from the digital image;
associating an object with each extracted text and graphic identifier;
using the extracted text to assign classes and identifiers to at least some of the associated objects;
determining a location in the image of at least some of the associated objects;
saving the assigned identifiers and locations in the image of the associated objects to a data set; and
generating the representation of the map in which:
instances of objects comprise the associated objects for which the server determined classes and relative locations appear as instances of objects, and
locations in which no objects were detected appear as open areas.

3. The method of claim 1 further comprising, by a server:
receiving a digital image file of a floor plan of the indoor location;
parsing the digital image file to identify objects within the floor plan and locations of the identified objects within the floor plan;
assigning classes and identifiers to at least some of the identified objects;
determining a location in the image of at least some of the identified objects;
saving the assigned identifiers and locations of the identified objects to a data set; and
generating the representation of the map in which:
the identified objects for which the server determined classes and relative locations appear as instances of objects, and
locations in which no objects were detected appear as open areas.

4. The method of claim 1, further comprising outputting the shortest path on a display of the electronic device so that the shortest path appears on the map of the indoor environment.

5. The method of claim 1, wherein determining which the plurality of candidate paths is the shortest path comprises using Dykstra's algorithm or the Astar algorithm to determine the shortest path.

6. The method of claim 1, wherein determining the destination location comprises receiving, from a user of the electronic device, a selection of the destination location via a user interface by one or more of the following:
receiving an identifier of the destination location or of a destination object via an input field;
receiving a selection of the destination location or of the destination object on the map of the indoor environment as presented on the user interface; or
outputting a list of candidate designation locations or destination objects and receiving a selection of the destination object or the destination object from the list.

7. The method of claim 1, wherein:
the electronic device is an autonomous robotic device; and
the method further comprises, by a navigation system of the autonomous robotic device, moving the autonomous robotic device along the shortest path to the destination location.

8. The method of claim 1, wherein the method further comprises, by the processor of the electronic device executing a document processing application and, in the operation:
identifying the destination location as a location of a print device to which a document is to be printed; and
causing a document to be printed to the print device.

9. A system for determining a navigable path in an indoor environment, the system comprising:
a processor; and
a memory device containing programming instructions that are configured to cause the processor to:
determine a starting location and a destination location, wherein one or both of the locations in an indoor environment,
receive a graph representation of a map of the indoor environment, wherein the graph representation of the map includes instances of objects represented as nodes of the graph, and open area paths between objects represented as edges of the graph, and
without requiring data from any location-based tracking system that is external to the electronic device:
determine a plurality of candidate paths from the starting location to the destination location, wherein each of the plurality of candidate paths comprises a set of node-edge combinations that extend from the starting location to the destination location;
identify which of the plurality of candidate paths is a shortest path from the starting location to the destination location; and
select the shortest path as a path to navigate from the starting location to the destination location.

10. The system of claim 9, further comprising a memory device with additional programming instructions that are configured to cause a server to:
receive a digital image of a floor plan of the indoor environment;
extract text from the digital image;
associate an object with each extracted text and graphic identifier;
use the extracted text to assign classes and identifiers to at least some of the associated objects;
determine a location in the image of at least some of the associated objects;
save the assigned identifiers and locations in the image of the associated objects to a data set; and
generate the representation of the map in which:
instances of objects comprise the associated objects for which the server determined classes and relative locations appear as instances of objects, and
locations in which no objects were detected appear as open areas.

11. The system of claim 9, further comprising a memory device with additional programming instructions that are configured to cause a server to:
receive a digital image file of a floor plan of the indoor location;
parse the digital image file to identify objects within the floor plan and locations of the identified objects within the floor plan;
assign classes and identifiers to at least some of the identified objects;
determine a location in the image of at least some of the identified objects;
save the assigned identifiers and locations of the identified objects to a data set; and
generate the representation of the map in which:
the identified objects for which the server determined classes and relative locations appear as instances of objects, and
locations in which no objects were detected appear as open areas.

12. The system of claim 9, further comprising:
a display device; and
wherein the programming instructions are further configured to cause the processor to output the shortest path on the display device so that the shortest path appears on the map of the indoor environment.

13. The system of claim 9, wherein the instructions to determine which the plurality of candidate paths is the shortest path comprise instructions to use Dykstra's algorithm or the Astar algorithm to determine the shortest path.

14. The system of claim 9, wherein the instructions to determine the destination location comprise instructions to receive, from a user of the electronic device, a selection of a destination location via a user interface by one or more of the following:
receiving an identifier of the destination location or of a destination object via an input field;
receiving a selection of the destination location or of the destination object on the map of the indoor environment as presented on the user interface; or
outputting a list of candidate designation locations or destination objects and receiving a selection of the destination object or the destination object from the list.

15. The system of claim 9, wherein:
the processor is a component of an autonomous robotic device;
the autonomous robotic device further comprises a navigation system; and
the programming instructions also comprise instructions configured to instruct the processor to cause the navigation system to move the autonomous robotic device along the shortest path to the destination location.

16. The system of claim 1, further comprising additional programming instructions that are configured to cause the processor to execute a document processing application and, in the operation:
identify the destination location as a location of a print device to which a document is to be printed; and
cause a document to be printed to the print device.

17. A system for determining a navigable path to a print device in an indoor environment, the system comprising:
a processor; and
a memory device containing programming instructions that are configured to cause the processor to:
execute a document processing application and, in the operation, cause a document to be printed to a print device in an indoor environment,
identify a location of the print device to which a document is to be printed, and
receive a graph representation of a map of the indoor environment, wherein the graph representation of the map includes instances of objects represented as nodes of the graph, and open area paths between objects represented as edges of the graph, wherein at least one of the instances of objects corresponds to the print device, and
without requiring data from any location-based tracking system that is external to the system:
determine a plurality of candidate paths from a starting location to the location of the print device, wherein each of the plurality of candidate paths comprises a set of node-edge combinations that extend from the starting location to the location of the print device;
identify which of the plurality of candidate paths is a shortest path from the starting location to the location of the print device; and
select the shortest path as a path to navigate from the starting location to the location of the print device.

18. The system of claim 17, further comprising:
a display device; and
wherein the programming instructions are further configured to cause the processor to output the shortest path on the display device so that the shortest path appears on the map of the indoor environment.

19. The system of claim 17, wherein the instructions to determine which the plurality of candidate paths is the shortest path comprise instructions to use Dykstra's algorithm or the Astar algorithm to determine the shortest path.

20. The system of claim 17, wherein:
the processor is a component of an autonomous robotic device;
the autonomous robotic device further comprises a navigation system; and
the programming instructions also comprise instructions configured to instruct the processor to cause the navigation system to move the autonomous robotic device along the shortest path to the location of the print device.
